(19) United States
(12) Patent Application Publication
(10) Pub. No.: US 2004/0215658 A1
(43) Pub. Date: Oct. 28, 2004

(54) Learning content management system

(76) Inventors: Andrew James Carnegie, London (GB); Dennis Verrios, London (GB); Kevin Anthony Bowd, London (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/485,498

(22) PCT Filed: Jul. 30, 2002
(86) PCT No.: PCT/GB02/03456

(30) Foreign Application Priority Data
Jul. 30, 2001 (GB) 0118555.2

(51) Int. Cl. G06F 7/00

(52) U.S. Cl. 707/104.1

(57) ABSTRACT

A content management system for the information content of a browser based intranet or internet-based learning management system (“LMS”) which includes movie components produced by a standard movie-editing program, the content management system including means for interactively adding, amending or deleting movie components without specific program editing being required.

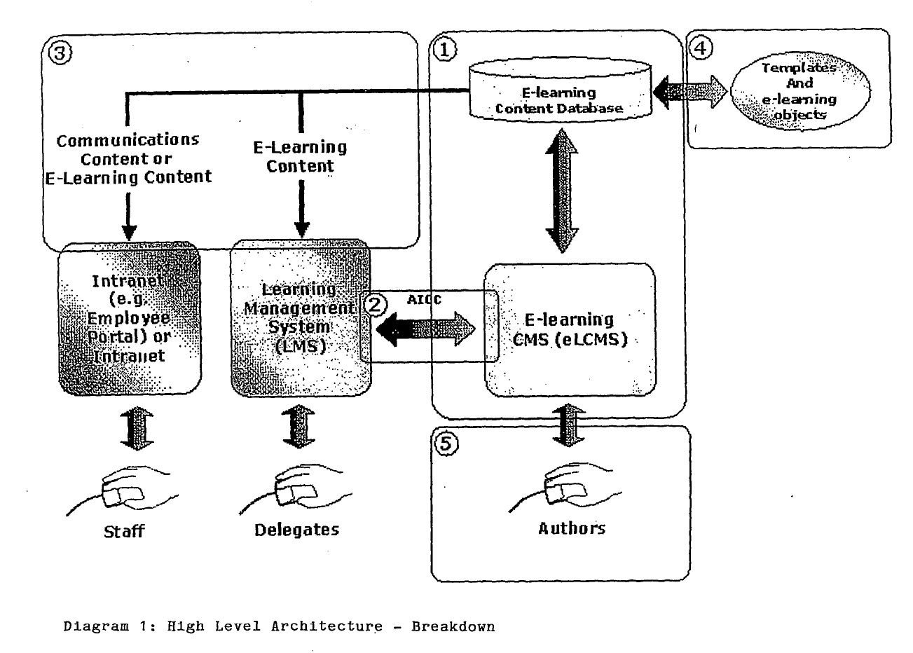

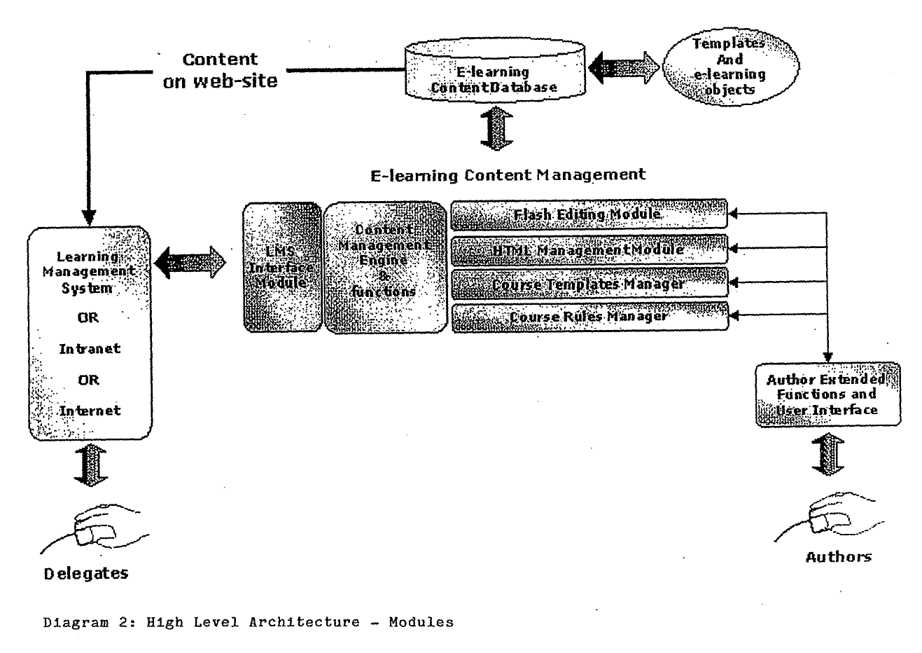

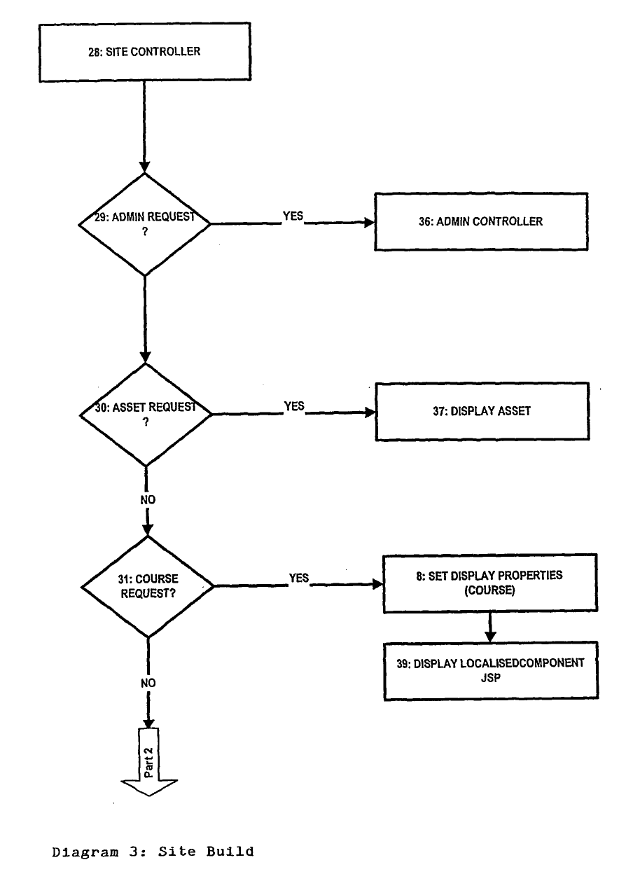

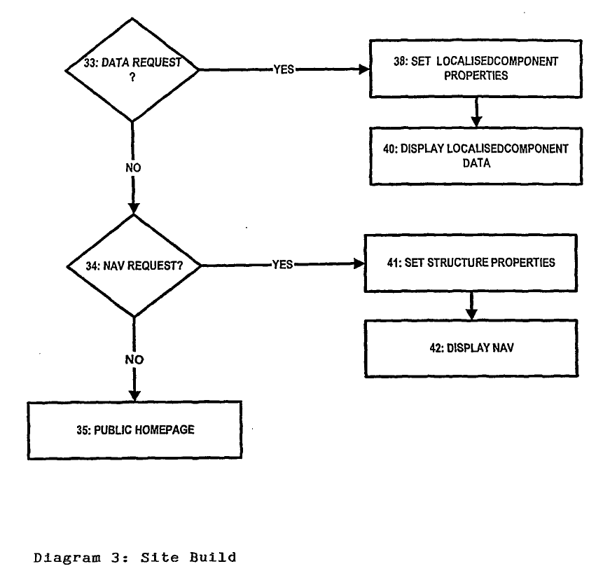

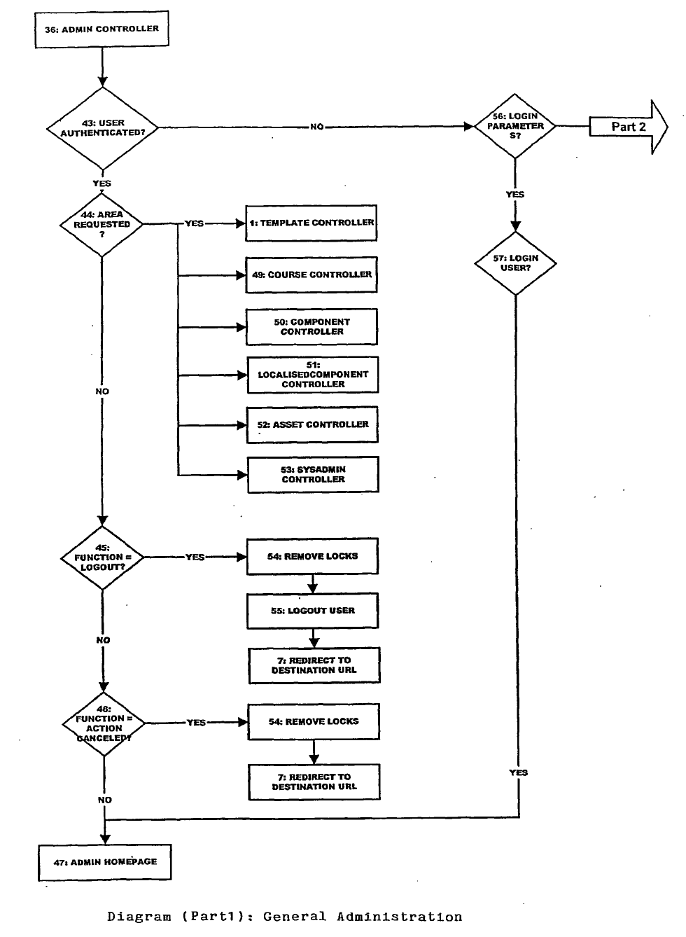

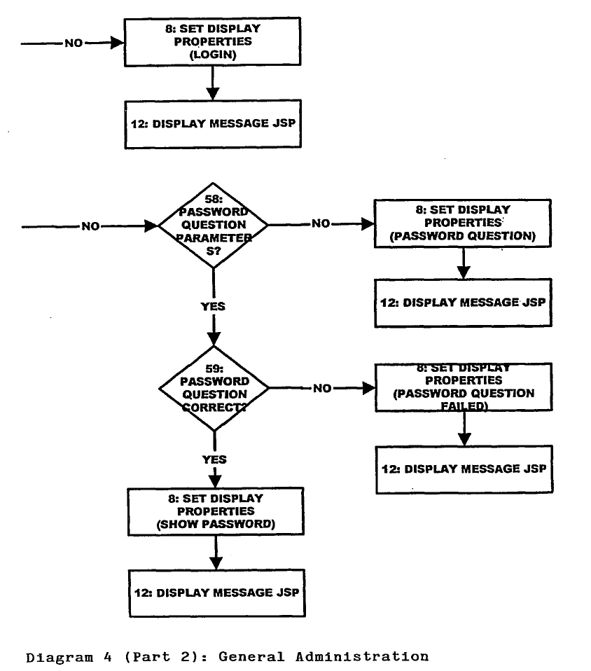

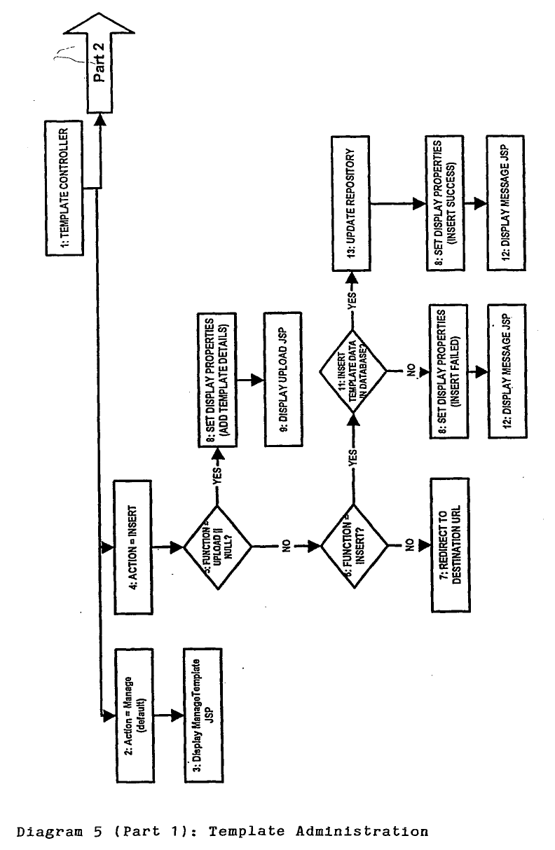

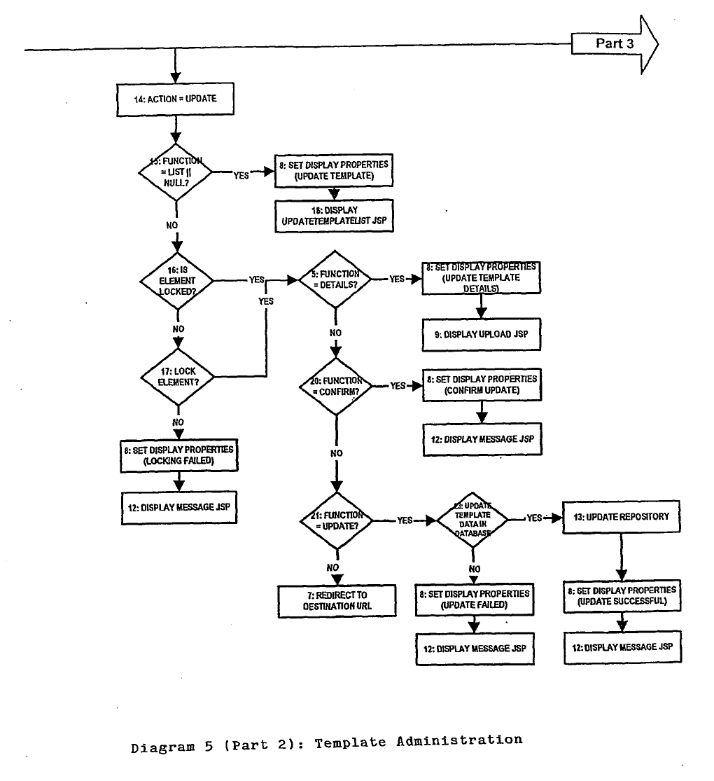

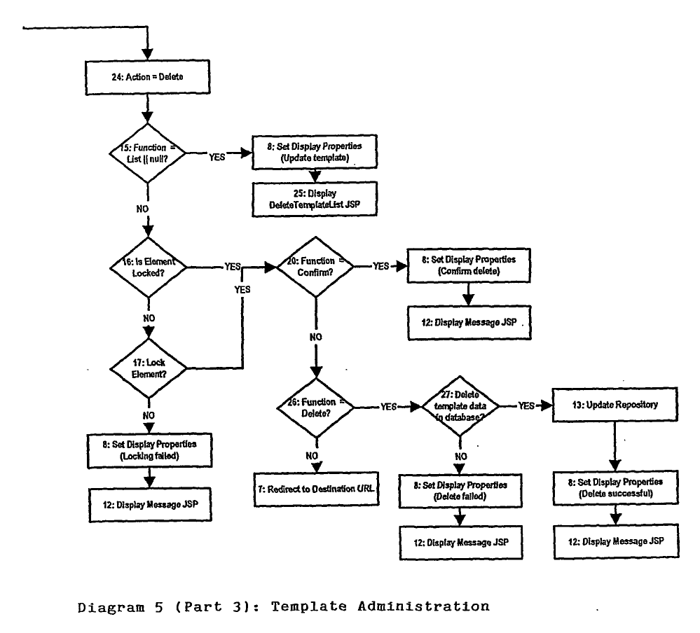

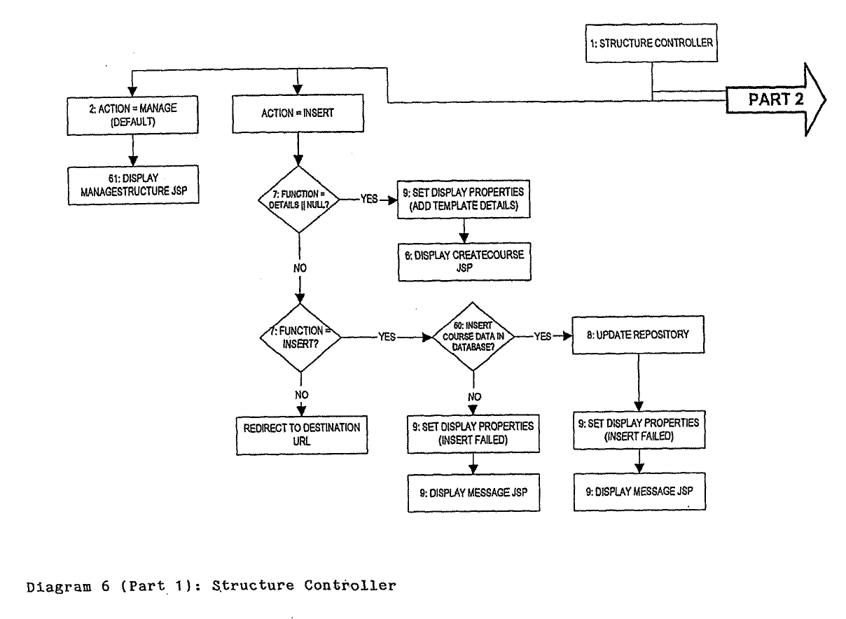

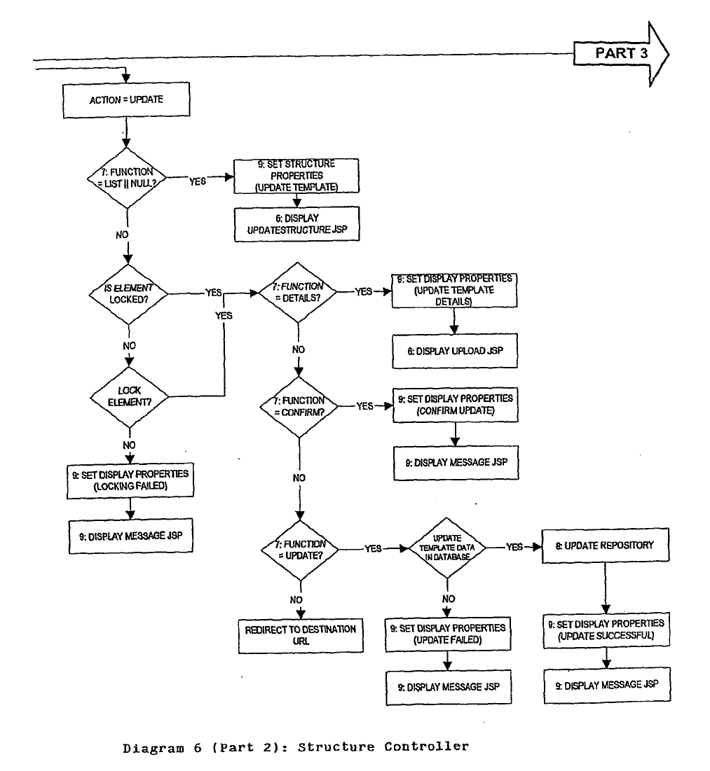

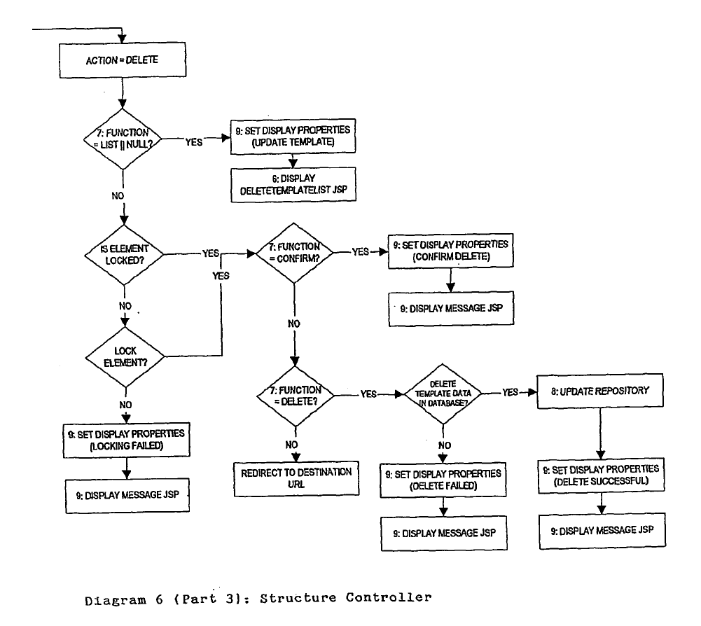

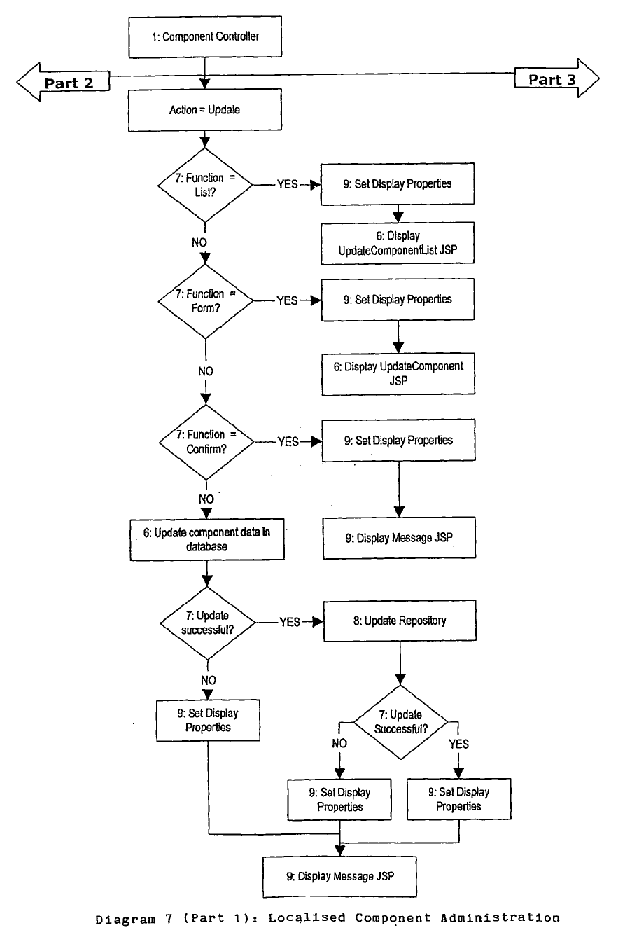

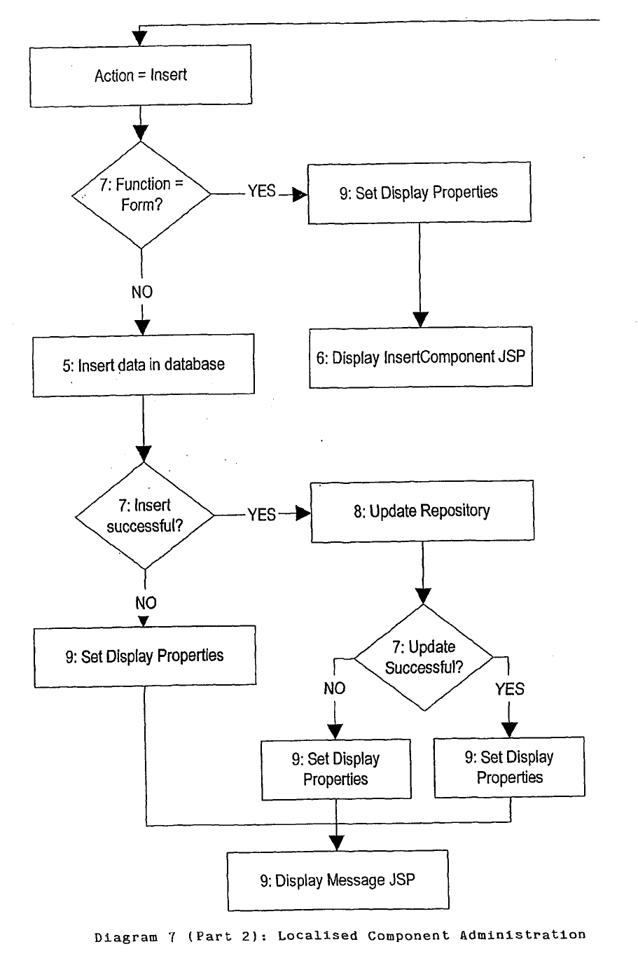

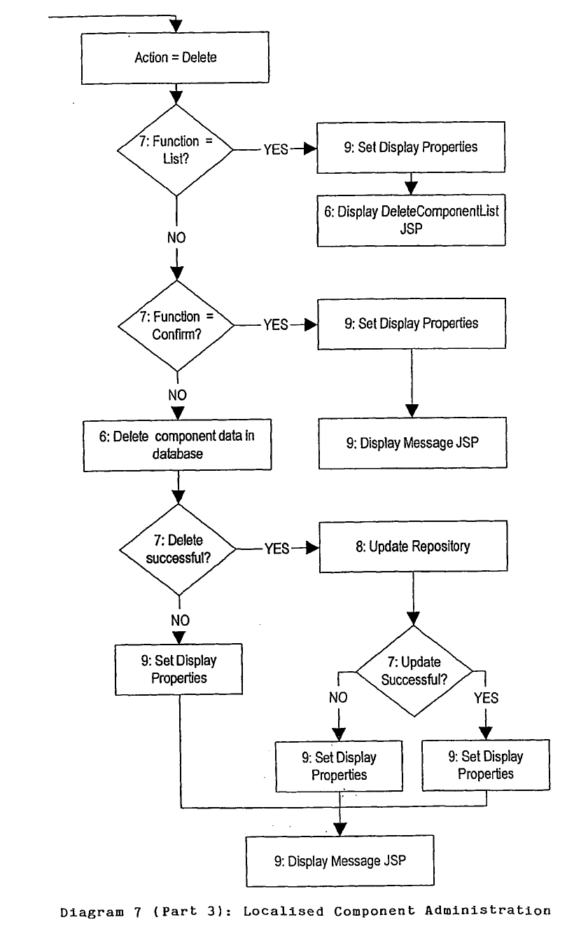

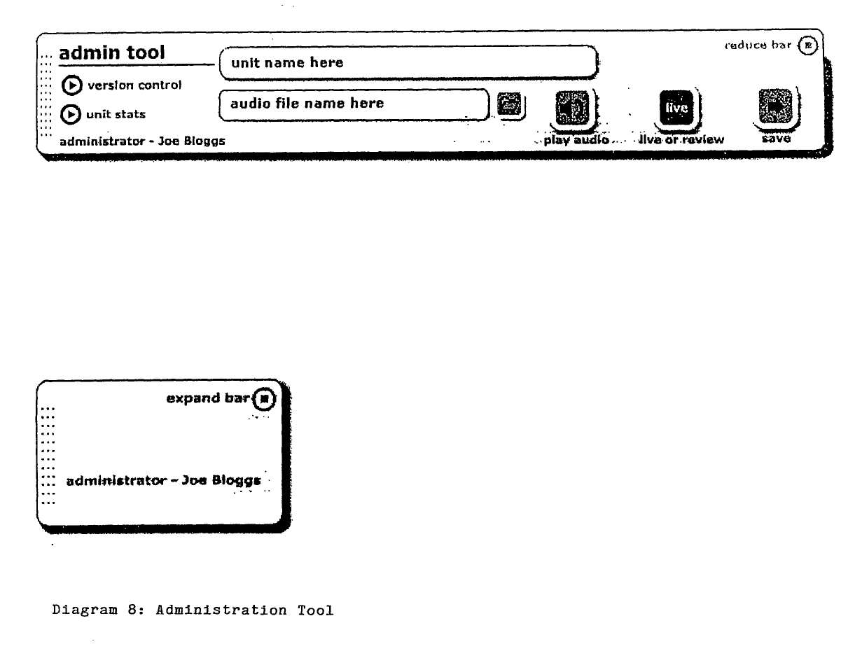

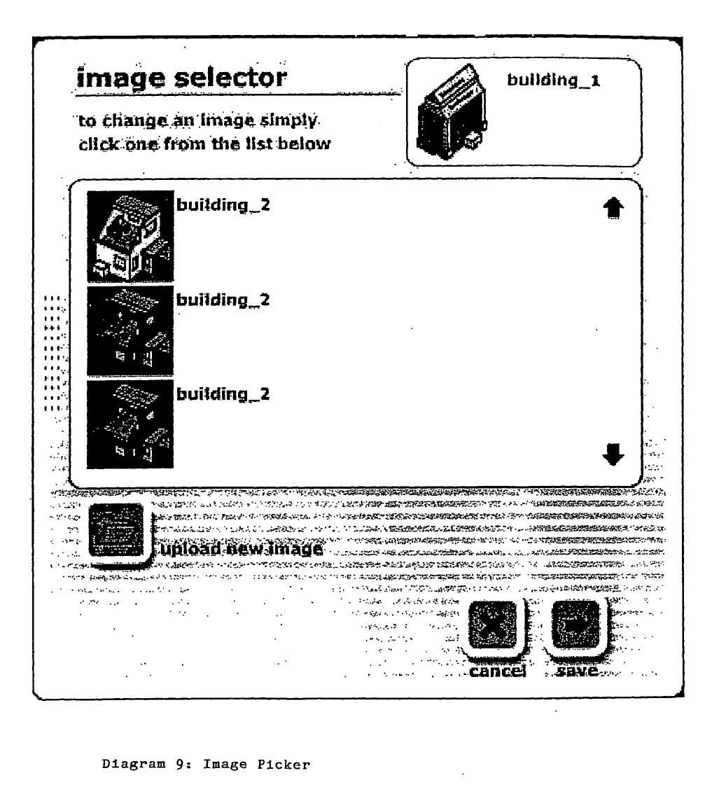

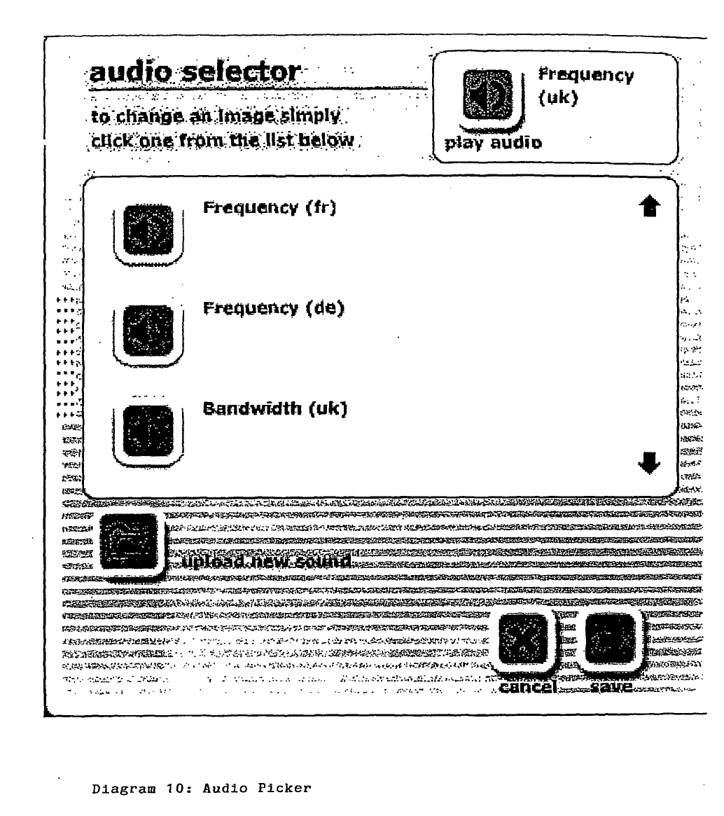

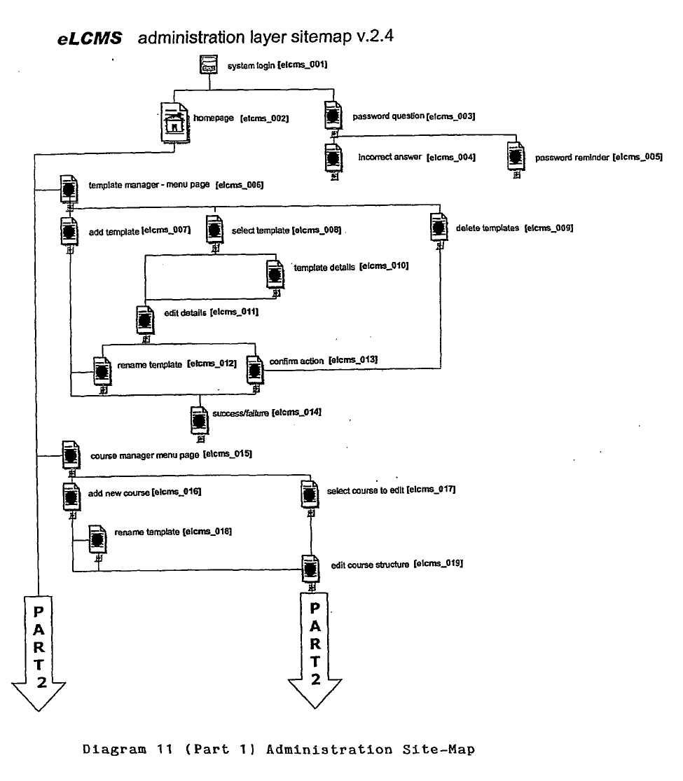

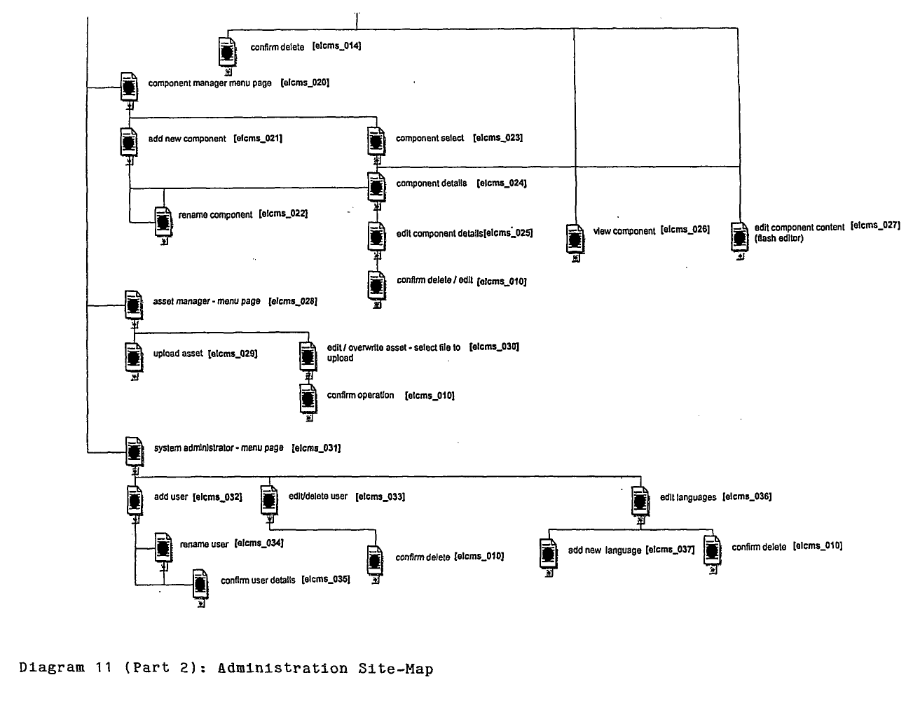

1. GENERAL INTRODUCTION

This invention relates to a method of managing the information content of internet-based learning systems which include “FLASH” movie components. It is particularly concerned with a system which is adapted for use by non-technical personnel. This system is referred to below as an “e-Learning Content Management System” or eLCMS.

The eLCMS enables the user to add, amend or delete screens, without having to carry out “FLASH” programming. This enables learning material to be changed or adapted in a cost effective and timely fashion.

The invention also extends to a method for designing attractive and interactive learning objects using Macromedia (RTM) Flash Movies coupled with a highly scaleable database such as Microsoft SQL or Oracle (RTM) with no technical knowledge other than the process of creating the Initial templates and objects so that they can be subsequently utilised in the eLCMS

2. SUMMARY LIST OF DIAGRAMS

1. High level architecture—Breakdown

2. High level architecture—Modules

3. Site Management Process Flow

4. General Administration Process Flow

5. Template Administration Process Flow

6. Structure Controller

7. Localised Component Administration Process Flow

8. Administration Navigation Bar

9. Image Picker

10.Audio Picker

11. Administration Sitemap

3. SCOPE OF FUNCTIONALITY

Diagram 1 shows five key areas defined as:

1. The eLCMS and the accompanying database

2. Integration of the eLCMS with an LMS

3. The content delivery mechanism for both e-Learning and Communications content

4. Provision of templates and e-learning objects for use in a modular form

5. The process of Implementation of the application within an end users environment (including training, business processes, integration with infrastructure etc).

3.1 The eLCMS and the Accompanying Database

The eLCMS meets the primary objectives as outlined below:

Allow for the creation and maintenance of FLASH (Macromedia® technology) based components by non technologists i.e. non users of Macromedia's® Flash Software.

Allow for these FLASH components to be stored and managed within an architecture that supports component reusability

Non e-Learning and e-Learning content is also able to be delivered via an internet based browser

The application allows a user to render a FLASH component via the use of templates and allow these templates to allow a user a degree of flexibility about their sub-components e.g. addition/update of audio, text and images

The application includes publishing flow functions to ensure that the components viewed by an end-user have been approved by relevant members e.g. Training Team

The application allows for the viewing and managing of versions of the components

The application supports multiple localized versions of live content including those of Double-Byte countries e.g. Japan

3.2 Integration of the CMS with an LMS

The eLCMS is developed to ensure it uses AICC and SCORM (Sharable Content Object Reference Model) compatibility functions that are compliant with Learning Management Systems (LMS) as follows:

All FLASH components that are used in an eLearning capacity, can be delivered to an end-user/delegate VIA the LMS

The application communicates with an LMS the relevant information (course, activity, user details) required to ensure the LMS can deliver its core functions

3.3 Development of the Content Delivery Mechanism for Both e-Learning and Communications Content

The content delivery mechanism is developed to support the following requirements:

e-Learning

All e-Learning content must be delivered to the trainee/delegate

Non e-Learning Communications

All non e-Learning content (classed as Communications) must be delivered via a web browser

4. GENERAL ARCHITECTURE

The eLCMS architecture shown in diagram 2 has 7 key modules:

1. Content Management Engine—this allows for the management of eLearning objects, for the upload of new objects, for the keeping of multiple versions and historical transactions, for the tracking of user activity and the delivery of content to either a web site or an LMS.

2. Flash Editing Module—this is the hub of the application and allows for Text, Images, Audio and other Flash movies to be altered (changed, moved, removed, added) while in the flash movie itself without any knowledge of Macromedia®'s Flash editing tool.

3. HTML Management Module—this is the set of administration screens that allow the content to be managed covering aspects such as Author management, Configuration parameter entry, Course editing and Course Creation.

4. Course Templates Manager—this manages the process of adding and maintaining templates that are used as the starting point for the development of any Flash eLearning course.

5. Course Rules Manager—this is the tool that ensures that the client's specific rules for the delivery of an eLearning course are adhered to. Here, parameters such as the maximum time for any part of the course, the maximum number of topics, the enforcement of the addition of a review object etc.

6. A content Database—this is the data structure that defines the way content is stored by the eLCMS and on what physical Database (Oracle and SQL Server) these unique data structures are kept.

7. LMS interface Module—this module communicates with an LMS the relevant information (course, activity, user details) required to ensure the LMS could deliver its core functions.

5. DETAILED OUTLINE

The following detail is provided to show how the program suite will perform its actions.

5.1 Site Management

Diagram 3 shows the process that controls all requests made to the site. The path of the request is analysed to determine which part of the site is requested. All admin requests are forwarded to the Admin Process. Public requests for components, courses and assets are forwarded to the appropriate controlling processes.

5.2 Administration Request Management

Diagram 4 shows the process controls the admin requests. If the user is not authenticated, the login screen is displayed. After being authenticated the admin homepage is displayed. This contains links to the admin areas (e.g. template, course, component, asset and sysadmin).

5.3 Template Management

Diagram 5 shows the process involves managing, inserting, updating or deleting a template. If the user is authenticated, they are presented with the appropriate form. Based on the options selected and data posted, the template data is updated in the database. A message page displays the success or failure of the process.

5.4 Structure Controller

Diagram 6 shows the process involving managing, inserting, updating or deleting course structure. If the user is authenticated, they are presented with the appropriate form. Based on the options selected and data posted, the course structure data is updated in the database. A message page displays the success or failure of the process.

5.5 Localised Component Administration

Diagram 7 shows the method by which Objects (definable units of content e.g. a Page) are manipulated and managed. This includes the ability to localize these objects to take into account foreign languages so that an object can exist in multiple states e.g. English and German

5.6 Breakdown of Diagram Descriptors

The following table lists out the elements shown in the above process flow diagrams.

| No | Name | Description |
|---|---|---|
| 24 | Action = Delete? | This process determines that the delete action is required and |
| | | calls the delete( ) function. This function continues the |
| | | processing for this action. |
| | Action = Display? | This process determines that the display action is required and |
| | | calls the display( ) function. This function continues the |
| | | processing for this action. |
| 3 | Action = Insert? | This process determines that the insert action is required and |
| | | calls the insert( ) function. This function continues the processing |
| | | for this action. |
| 2 | Action = Manage? | This process determines that the manage action is required and |
| | | calls the manage( ) function. This function continues the |
| | | processing for this action |
| 14 | Action = Update? | This process determines that the update action is required and |
| | | calls the update( ) function. This function continues the |
| | | processing for this action. |
| 36 | Admin Controller | This process is initiated via a URL call. The request, response, |
| | | session and site objects are made available. It then forwards the |
| | | request to one of the admin area controllers, e.g. Template |
| | | Controller, Component Controller, Asset Controller etc. |
| 47 | Admin Homepage | Displays the AdminHomepage JSP. |
| | | Links to each of the admin areas are provided. These links are |
| | | of the form/admin/?area=template |
| 29 | Admin Request? | Determines that the request is for the admin part of the site |
| | | (URL's with a path/admin/*). Forwards the request to the |
| | | AdminController servlet. |
| 44 | Area Requested? | Determines that an area has been requested and forwards the |
| | | request to the controller for that area. |
| 52 | Asset Controller | This process controls the processing for asset functionality. The |
| | | actions for this area are display (default), manage, insert, |
| | | update and delete. A function exists for each action, e.g. insert |
| | | ( ), delete ( ) etc. |
| 30 | Asset Request? | Determines that the request is for the asset part of the site |
| | | (URL's with a path/asset/*). Returns the asset to the client. |
| 50 | Component | This process controls the processing for component |
| | Controller | functionality. The actions for this area are manage, insert, |
| | | update and delete. A function exists for each action, e.g. insert |
| | | ( ), delete ( ) etc. |
| 49 | Course Controller | This process controls the processing for course functionality. |
| | | The actions for this area are manage, insert, update and delete. |
| | | A function exists for each action, e.g. insert( ), delete( ) etc. |
| 31 | Course Request? | Determines that the request is for a localised component within |
| | | the course structure (URL's with a path/courses/*). Sets the |
| | | properties for the LocalisedComponent and displays the JSP. |
| 33 | Data Request? | Determines that the request is for the data part of the site |
| | | (URL's with a path/data/*). Sets the properties for the |
| | | LocalisedComponent and displays the JSP. |
| 27 | Delete Template | Deletes the specified template from the database. Removes the |
| | Data in Database? | entries from both the TEMPLATE table and the BLOB table. |
| | | If the template is used by any component, the process fails. |
| | | Processing is split for success or failure. |
| 37 | Display Asset | Returns the binary data of the requested asset to the client. |
| | Display | Displays the CreateCourse JSP. This allows the user to select |
| | CreateCourse JSP | a component to become the root element of a new course tree. |
| 25 | Display | This process forwards the request to the DeleteTemplateList |
| | DeleteTemplateList | JSP. The JSP displays all the templates available for deletion. |
| | JSP | Only templates that are not used by any components may be |
| | | deleted. |
| 40 | Display | Returns the Localised Component data to the client as an XML |
| | LocalisedComponent | file. |
| | Data | |
| 39 | Display | Displays an HTML page containing the standard layout of the |
| | LocalisedComponent | localised component. |
| | JSP | The standard layout contains a Flash object tag to the template |
| | | for the component, and passes the appropriate parameters to |
| | | the Flash object for it to reference it's data source. |
| | Display | This process forwards the request to the ManageComponent |
| | ManageComponent | JSP. The JSP displays the manage component page |
| | JSP | appropriate to the user. |
| 61 | Display | This process forwards the request to the ManageStructure JSP. |
| | ManageStructure | The JSP displays the manage structure page appropriate to the |
| | JSP | user. |
| 3 | Display | This process forwards the request to the ManageTemplate JSP. |
| | ManageTemplate | The JSP displays the manage template page appropriate to the |
| | JSP | user. |
| 12 | Display Message | This process forwards the request to the Message JSP. The |
| | JSP | JSP uses the properties set in the Display bean and displays the |
| | | page accordingly. |
| 42 | Display Nav | Returns the course structure data to the client as an XML file. |
| 18 | Display Update | This process forwards the request to the UpdateTemplateList |
| | Template List JSP | JSP. The JSP displays all the templates available for updating. |
| 9 | Display Upload JSP | This process redirects the request to the Upload JSP. The JSP |
| | | uses the properties set in the Upload bean to format the |
| | | response page. |
| 46 | Function = Action | Determines if the action cancelled function is called. The |
| | Cancelled? | processing splits for a true or false answer. |
| 20 | Function = Confirm? | This process determines whether the confirm function is |
| | | required. The processing splits for a true or false answer. |
| | | This process does not perform generic functionality. The actual |
| | | processing required is determined by the area, action and |
| | | function parameters for each occurrence of this process. |
| | | For example, within the template area, the update template |
| | | action, and the confirm function, this process will include the Set |
| | | Display Properties process and the Display Message JSP |
| | | process. The Display properties in this example will include |
| | | some help text, a submit button (going to the next stage in the |
| | | process), and a cancel button (going first to the Action |
| | | Cancelled process on the AdminController, and then forwarded |
| | | to the Admin admin homepage). |
| | Function = Data? | This process determines that the data function is required. The |
| | | processing is split for either a true or false option. |
| | | This process does not perform generic functionality. The actual |
| | | processing required is determined by the area, action and |
| | | function parameters for each occurrence of this process. |
| | | For example, within the localised component area, the display |
| | | action, and the data function, this process will set the properties |
| | | for the LocalisedComponent bean and then display the |
| | | LocalisedComponentData JSP. |
| 26 | Function = Delete? | This process determines that the delete function is required. The |
| | | processing is split for either a true or false option. |
| 5 | Function = Details ∥ | This process determines that the details function is required. |
| | null? | The processing is split for either a true or false option. |
| 6 | Function = Insert? | This process determines that the insert function is required. The |
| | | processing is split for either a true or false option. |
| 15 | Function = List ∥ | Determines that the list function is required. The processing is |
| | null? | split for either a true or false option. |
| 45 | Function = Logout? | Logs the user out. All locks are removed and the session is |
| | | expired. The user is redirected to the admin login screen. |
| 21 | Function = Update? | This process determines that the update function is required. |
| | | The processing is split for either a true or false option. |
| 60 | Insert course data in | Inserts a new root course component into the database. |
| | database? | |
| 11 | Insert Template Data | This process creates a Template object from the parameters in |
| | in Database? | the request object. It checks that the name specified for the |
| | | template does not already exist. If the name does exist the |
| | | function fails indicating that the name exists. |
| | | It then calls template.insert( ) function to insert values in the |
| | | TEMPLATE and BLOB table. |
| | | Processing is split for success or failure. |
| 16 | Is Element Locked? | Checks to see if the current user has a lock for the particular |
| | | element. If the lock is valid, the lock is refreshed, i.e. the created |
| | | time is reset to the current time (lock timeouts are not |
| | | cumulative from initial setting of the lock, but rather the time-out |
| | | period restarts every time the locked object is refreshed.) |
| | | Processing splits for true or false. |
| 51 | LocalisedComponent | This process controls the processing for localised component |
| | Controller | functionality. The actions for this area are display (default), |
| | | manage, insert, update and delete. A function exists for each |
| | | action, e.g. insert ( ), delete ( ) etc. |
| 32 | LocalisedComponent | Determines that the request is for a localised component (URL's |
| | Request? | with a path/components/*). Sets the properties for the |
| | | LocalisedComponent and displays the JSP. |
| 17 | Lock Element? | Attempts to lock an element for the current user. Processing |
| | | splits for success or failure. |
| 56 | Login Parameters? | Determines if login parameters have been passed in the |
| | | request. Processing splits for true or false. |
| 57 | Login User? | Attempts to log the user in. If no login parameters are passed, |
| | | the process fails. Processing splits for success or failure. |
| 55 | Logout User | Logs the user out. |
| 34 | Nav Request? | Determines that the request is for the nav part of the site (URL's |
| | | with a path /nav/*). Sets the properties for the |
| | | LocalisedComponent and displays the JSP. |
| 59 | Password Question | Checks if the user answered the password question correctly. |
| | Correct? | Processing splits for true or false. |
| 58 | Password Question | Determines if password question parameters have been passed |
| | Parameters? | in the request. Processing splits for true or false. |
| 35 | Public Homepage | Displays the public homepage for the site. |
| 7 | Redirect to | Redirects the user to the destination URL passed in the request. |
| | Destination URL | |
| 54 | Remove Locks | Removes one or many locks for the current user. |
| 8 | Set Display | This process sets the properties for the Display bean. This bean |
| | Properties | is used by many JSPs to format the output page. The process |
| | | then forwards the request to the appropriate JSP. |
| 38 | Set Localised | Prepares the LocalisedComponent bean based on the request |
| | Component | parameters. |
| | Properties | |
| 41 | Set Structure | Prepares the Structure bean based on the request parameters. |
| | Properties | |
| 28 | Site Controller | This process controls the processing for the site. The request is |
| | | analysed and passed to the appropriate controlling servlet. |
| | | Requests that do not match one of the controllers are forwarded |
| | | to the Public Homepage process |
| 53 | Sysadmin Controller | This process controls the processing for sysadmin functionality. |
| | | The actions for this area are manage, insert, update and delete. |
| | | A function exists for each action, e.g. insert( ), delete( ) etc. |
| 1 | Template Controller | This process controls the processing for template functionality. |
| | | The actions for this area are manage, insert, update and delete. |
| | | A function exists for each action, e.g. insert ( ), delete ( ) etc. |
| 13 | Update Repository | This process updates the flat file repository. |
| | | For Components, all the Localised components at Live status |
| | | are added to the repository, and all other statuses are removed. |
| | | For binary data, the binary file is inserted, updated or |
| | | removed—as required. |
| | | A log file records the activity for the repository changes as well |
| | | as error messages for failed changes. This can be used to |
| | | validate the repository. |
| 23 | Update Template | This process uses the Template object for the required template |
| | Data in Database? | It checks that the new name specified for the template does not |
| | | already exist. If the name does exist the function fails indicating |
| | | that the name exists. |
| | | It then calls template.update( ) function to insert values in the |
| | | TEMPLATE and BLOB table. |
| | | Processing is split for success or failure. |
| 43 | User Authenticated? | This process checks that the user has permission for the |
| | | requested area and action. |
| | | For each role that the user is a member of, |
| | | role.checkAccess(Area,Action) is called. If any role has access, |
| | | the user is authenticated. If the user is not authenticated, an |
| | | error message is displayed. If the user is authenticated, |
| | | processing continues. |

5.7 Administration Sitemap

Diagram 11 displays the navigation through the application that an administrator can take and the related functions.

6. FLASH EDITING MODULE ARCHITECTURE

There are three levels that are being used. The first contains the menu, the second the course component and the third, which is optional, the admin toolbar.

6.1 Menu

This is the main movie, which will act as a controller for both administration and user views. All required functions for the displaying of components would be written here and called as needed from the component; this is to ensure ownership (by tentendigital) of all flash code. Functions required for sending data to the eLCMS will not be written here as should only be loaded when required. Data loaded (as XML) into this movie will define which mode (admin or user) to operate, and will also populate any loaded component with text, images and sound.

The basic functions are highlighted below:

Customisable in appearance

XML driven

Functions declared for all user component population

In particular the declared functions will allow:

Mode selection (admin or user)

XML parsing (receiving)

Bookmarking

When the menu is loaded an XML document will be loaded to create the menu structure and set the mode. This will allow the menu to know the names of components, the location of the swf files to be used and the XML documents to populate the swfs. If a bookmark is passed then that component will be loaded, else the default component homepage will be loaded. When a component is selected the required XML file will be loaded and then the component will be loaded into level 1.

6.2 Component

These are the files to be created by the content provider. They will contain text holders, image holders, and a sound file holder (images and sounds are swf's). When a component is loaded it will call the menu and request data. This data will already be loaded and parsed by the menu. The data will then populate the component. If the menu is set to admin mode then the component will be set to admin mode whereby all text fields are editable and all images and sound files are changeable. Variables will temporarily be stored in this level and passed to the admin toolbar on request for parsing, and sending to the eLCMS. In order to cause minimal change to the standard Flash development processes a series of movie clips (possibly smart clips) will be created-to aid the development of components.

6.3 Administration Toolbar

As shown in diagram 8—this will be loaded if the menu is set to admin mode. Variables may be set on this level and passed to the menu as required. The toolbar will be responsible for the selection of sound files, version control, status setting and any other CMS functionality. Any functions required for parsing to XML will be declared here, this is to avoid loading code in the menu when not needed. When the administrator requests to save changes all variables will be passed Into this level, parsed and sent to the eLCMS. The image picker will be called from here.

6.4 Image and Audio Picker

As shown in diagram 9—When requested the image picker will load, populating itself from an XML document. This will create a tree structure of categories. Once a category has been chosen a new XML document will be loaded defining the names and locations of all available images (swfs). These will be displayed so that one can be selected. This same functionality applies to audio objects as shown in diagram 10.

GLOSSARY

Macromedia's® Flash=is a tool that the US company, Macromedia based at 600 Townsend Street, San Francisco, Calif. 94103, USA has developed for delivering interactive and animated content via a web browser. It is sometimes referred to as “FLASH MOVIES” or “MOVIE”, the source code of a FLASH MOVIE is suffixed by a “.FLA” while the compiled viewable version is suffixed by an “.SWF”.

e-Learning=Content, that supports the educational process, delivered via Internet (Internet Protocol (IP) based) networks. In the context of this document, all e-Learning is delivered via a web browser and in the format of Macromedia's® Flash movies.

e-Learning Content Management System (eLCMS)—the focus of an eLCMS is to manage and deliver content that the learner needs when the individual needs it.

Learning Management Systems (LMS)—the value proposition of an LMS is cost-efficient training administration. eLCMS's and LMS's are not only distinct, they also complement each other well.

Content Management Systems (CMS)—The primary difference between CMS and eLCMS is that the former is a horizontal software application and the latter is a vertical market software application. An eLCMS requires development and deployment layers that cannot be addressed by the generalised content management features found in a CMS. eLCMS's are designed with prescribed learning In mind.

1. A content management system for the information content of a browser based intranet or internet-based learning management system (“LMS”) which includes movie components produced by a standard movie-editing program, the content management system including means for interactively adding, amending or deleting movie components without specific program editing being required.

2. A system according to claim 1 which includes components comprising templates and/or learning objects that are arranged to be stored in a database.

3. A system according to claim 1 or claim 2 in which the LMS includes movie components produced with Macromedia Flash.

4. A system according to any one of the preceding claims further comprising means for adding, amending or deleting HTML content.

5. A system according to any preceding claim in which the components include audio, text and image elements.

6. A browser-based learning content management system comprising:
(a) an e-learning content database for storing templates and e-learning objects; and
(b) means for editing the content of the learning management system including authoring means for interactively adding, amending or deleting movie components without specific program editing being required.

7. A browser-based learning management system including
(a) a learning-content management system according to claim 6 for managing e-learning content; and
(b) means for delivering content to administrative staff and/or learning system delegates.

8. A browser-based learning content management system according to claim 6 or claim 7 in which the authoring means further comprises:
(a) means for managing HTML content;
(b) means for managing course templates; and
(c) means for managing course rules.

9. A browser-based learning content management system comprising
(a) a content management engine for controlling e-learning objects;
(b) a Flash editing module for interactively editing Flash movie content;
(c) an HTML management module for controlling HTML page content;
(d) a course templates manager for adding and monitoring templates for e-learning course developments;
(e) a course rules manager for controlling course administration rules;
(f) a content database for storing the learning content of the system; and
(g) an LMS interface module for communicating the relevant information from the content management system to the learning management system.
